(19) United States
(12) Patent Application Publication
(10) Pub. No.: US 2011/0285489 A1
(43) Pub. Date: Nov. 24, 2011

(54) FORCE CONCENTRATOR

(76) Inventor: Cindy Lee Rinella, Portland, OR (US)

(21) Appl. No.: 12/786,120

(22) Filed: May 24, 2010

(51) Int. Cl. H01F 7/02

(52) U.S. Cl. 335/306

(57) ABSTRACT

An apparatus for producing mechanical work is disclosed. The apparatus includes a target magnet that can be connected to a target object, a guide member that can transmit a fluid along a guide path and an initiator magnet having a working side facing a corresponding side of the target magnet with a same magnetic polarity as the corresponding side. The initiator magnet is slidably received within the guide path of the guide member and is movable toward the target magnet along the guide path under influence of the fluid transmitted by the guide member to thereby create an increasing repulsive force between the target magnet and the initiator magnet as a distance between the target magnet and the initiator magnet decreases to thereby move the target object.

### BACKGROUND

1. Technical Field

This disclosure relates to force concentrators and methods of using the same. More particularly, this disclosure relates to force concentrators for producing mechanical work.

2. Description of the Related Art

FIG. 1 is a schematic view of an apparatus for producing mechanical work. FIG. 2 is a graph illustrating the relationship between a mechanical force applied to the object shown in FIG. 1 and the frictional force on the object.

For an object which is supported by a supporting structure to move in the presence of an external mechanical force, the mechanical force acting upon the object must be greater than a static friction force between the object and the supporting structure. To sustain movement of the object relative to the supporting structure, the mechanical force acting upon the object must be greater than a kinetic friction force between the object and the supporting structure.

For example, to move an object, such as a model car 100 having non-moving wheels, relative to a supporting structure such as surface 104, a mechanical force (Fₐ), such as mechanical force 102 generated by moving air, acting upon the model car 100 must be greater than a static friction force (F_{f,s(max)}) between the model car 100 and the surface 104. To sustain movement of the model car 100 relative to the surface 104, the mechanical force 102 must be greater than a kinetic friction force (F_{f,k}) between the model car 100 and the surface 104. Often, however, the mechanical force (Fₐ) is greater than the kinetic friction force (F_{f,k}), but is less than the static friction force (F_{f,s(max)}).

Therefore, it would be desirable to provide an apparatus that is capable of initiating movement of objects relative to their supporting structures in the presence of an applied mechanical force (Fₐ) that sufficiently overcomes the kinetic friction force (F_{f,k}) between the object and the supporting structure but that, by itself, is insufficient to overcome the static friction force (F_{f,s(max)}) between the object and the supporting structure.

### BRIEF DESCRIPTION OF THE DRAWINGS

FIG. 1 is a schematic view of an object in the presence of a mechanical force,

FIG. 2 is a graph illustrating the relationship between a mechanical force applied to the object shown in FIG. 1 and the frictional force on the object.

FIG. 3 is a cross-sectional schematic view of an apparatus for moving a target object, according to one embodiment of the invention.

FIGS. 4 and 5 are end-views of the guide member shown in FIG. 3, according to some embodiments of the invention.

FIG. 6 is a schematic view illustrating how the apparatus shown in FIG. 3 produces mechanical work.

FIG. 7 is a graph illustrating the effect of the distance between a target object and the initiator magnet shown in FIG. 6 on the repulsive force experienced by the target object.

FIG. 8 is a cross-sectional schematic view of an apparatus for moving a target object, according to another embodiment of the invention.

FIG. 9 is a cross-sectional schematic view of an apparatus for moving a target object, according to another embodiment of the invention.

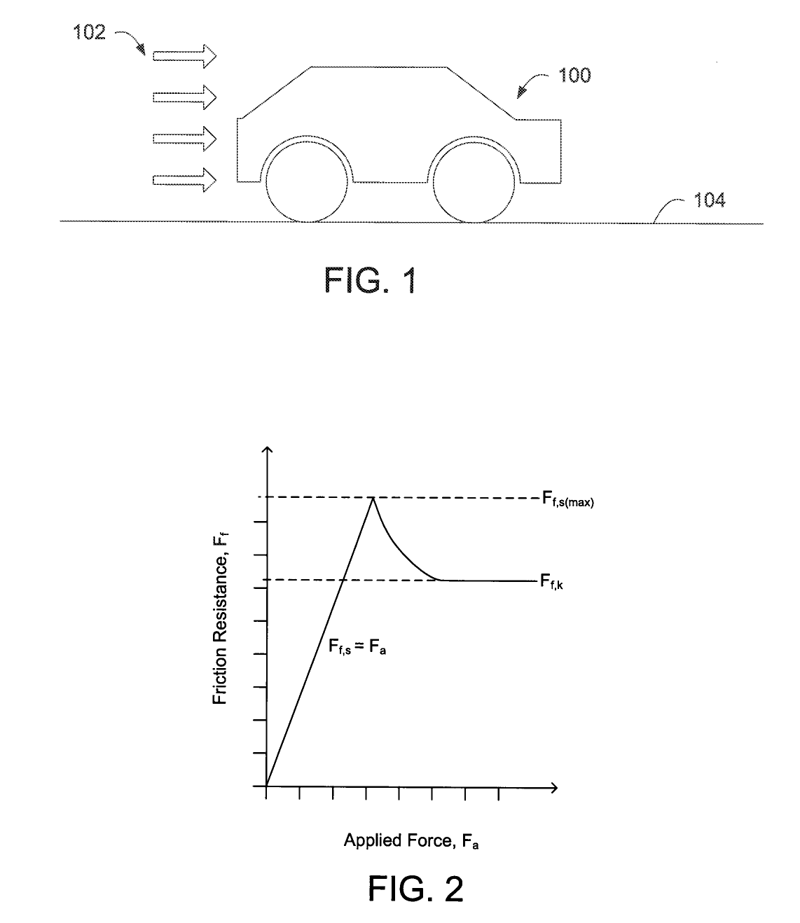

### DETAILED DESCRIPTION OF THE ILLUSTRATED EMBODIMENTS

Exemplary embodiments of the present invention will now be described more fully hereinafter with reference to the accompanying drawings. These embodiments, however, may be modified in many different forms and should not be construed as limited to the description expressly set forth herein. Rather, these embodiments are provided so that this disclosure will be thorough and complete, and will fully convey the scope of the invention to those skilled in the art. It will be understood that when an element is referred to as being “connected to,” “on,” etc., another element, it can be directly connected to or directly on the other element, or intervening elements may also be present. In contrast, when an element is referred to as being “directly connected to,” “directly on,” etc., another element, there are no intervening elements present. Like reference numbers refer to like elements throughout.

One embodiment of the present invention can be generally characterized as an apparatus for moving a target object to produce mechanical work. The apparatus includes a target magnet, a guide member, and an initiator magnet.

The target magnet is connected to the target object, and can be provided as a permanent magnet or an electromagnet. The target magnet can be connected to the target object in any manner such that the target magnet is movable relative to the target object, or such that the target magnet is not movable relative to the target object.

As used herein, a “target object” can refer to any structure which is supported or held in place by some support structure and which can be moved (e.g., slid, rotated, etc.) relative to the support structure. Exemplary target objects include (but are not limited to) pistons, wheels, axles, shafts, drums, turbine blades (e.g., of wind turbines, water turbines, etc.), plugs, caps, levers, pedals, diaphragms, and the like and combinations thereof. Target objects such as plugs and caps may be configured to at least partially seal openings of vessels such as the aforementioned pipes, bottles, tanks, etc., when pressed against an end of the vessel defining the opening. When a target object is a piston or the like, the corresponding support structure may, for example, be a cylinder surrounding the piston. When a target object is a wheel, turbine blade or the like, the corresponding support structure may, for example, be an axle, shaft, drum, etc., supporting the wheel or turbine blade. When a target object is an axle, shaft, drum, or the like, the corresponding support structure may, for example, be bearings or bushings where the axle, shaft or drum is supported. When a target object is a plug, cap, or the like, the corresponding support structure may, for example, be a portion of the vessel to be at least partially sealed.

The guide member defines a guide path along which a fluid can be transmitted. Exemplary fluids include (but are not limited to) gases, liquids, fluidized solids, slurries, and the like and combinations thereof. The guide path may be straight or curved, or may have at least one straight portion and at least one curved portion.

In one embodiment, the guide member includes a housing provided as a tubular member, wherein an inner surface of the housing defines the guide path. The initiator magnet can be coupled (e.g., moveably coupled) to the housing such that the initiator magnet is slidably received within the guide path. The housing has a fluid intake end and a repulsive end opposite the fluid intake end. An axis of the housing extends between the fluid intake end and the repulsive end. The guide path generally extends along the axis of the housing.

The fluid intake end is configured to receive the fluid. In one embodiment, the guide member includes a nozzle disposed at the fluid intake end of the housing. The nozzle may be provided as a convergent nozzle, having a diameter that decreases in the direction of fluid flow into the housing, to accelerate the fluid flow into the housing.

Fluid received by the fluid intake end is channeled into the housing along the guide path to press against and move the initiator magnet toward the repulsive end of the housing. In one embodiment, the guide member includes a flange disposed at the repulsive end of the housing. The flange may be configured to retain the initiator magnet within the guide path when the initiator magnet is moved by the fluid channeled along the guide path. In another embodiment, the guide member may include a flange disposed at the fluid intake end of the housing to retain the initiator magnet within the guide path between the fluid intake end and the repulsive end.

The initiator magnet can be provided as a permanent magnet or an electromagnet. The initiator magnet and the target magnet can be provided as the same type of magnet or as different types of magnets. Exemplary permanent magnets can be formed of materials such as iron, cobalt, nickel, gadolinium, dysprosium, samarium, neodymium, and the like and combinations thereof.

As mentioned above, the initiator magnet is slidably received within the guide path defined by the guide member. In one embodiment, the initiator magnet is disposed within the guide path such that a working side of the initiator magnet faces a corresponding side of the target magnet and has the same polarity as the corresponding side target magnet. Thus, the initiator magnet can be slidably moved along the guide path toward the repulsive end of the housing under the influence of a mechanical force generated by the fluid as it is transmitted by the guide member. When the guide member is disposed operably proximate to the target object, and when the initiator magnet is moved toward the repulsive end of the housing, the distance between the target magnet and the initiator magnet can be decreased to increase a repulsive force between the target magnet and the initiator magnet. When the repulsive force is greater than a friction force between the target object and the support structure, the target object will move relative to the support structure. In one embodiment, the friction force between the target object and the support structure is a kinetic friction force between the target object and the support structure. In another embodiment, the friction force between the target object and the support structure is a static friction force between the target object and the support structure.

The working side of initiator magnet can, in one embodiment, be substantially prevented from rotating within the guide path about an axis that is perpendicular to the axis of the housing when the initiator magnet is moved along the guide path toward the repulsive end of the housing. In one embodiment, dimensions of the initiator magnet are selected to substantially prevent the initiator magnet from rotating within the guide path about an axis that is perpendicular to the axis of the housing. In another embodiment, however, one or more suitably-dimensioned spacers may be coupled to the initiator magnet to substantially prevent the initiator magnet from rotating within the guide path about an axis that is perpendicular to the axis of the housing. The working side of the initiator magnet can, in another embodiment, be substantially prevented from rotating within the guide path about an axis that is parallel with the axis of the housing. In one embodiment, dimensions of the initiator magnet and the inner surface of the housing are selected such that the initiator magnet is substantially prevented from rotating within the guide path about an axis that is parallel with the axis of the housing. In another embodiment, however, one or more suitably-dimensioned spacers may be coupled to the initiator magnet to substantially prevent the initiator magnet from rotating within the guide path about an axis that is parallel with the axis of the housing.

In one embodiment, a lubricant, a bearing, or a combination thereof may be provided between the initiator magnet and the inner surface. Exemplary lubricants include dry lubricants such as polytetrafluoroethylene (PTFE), graphite, hexagonal boron nitride, molybdenum disulfide tungsten disulfide, and the like and combinations thereof. Exemplary bearings include bushings, rolling element bearing assemblies (e.g., including ball bearings, roller bearings, etc.), and the like and combinations thereof. It will be appreciated, however, that no lubricants or bearings may be provided between the initiator magnet and the inner surface of the housing. In one embodiment, the aforementioned one or more spacers are provided as one or more bearings.

In one embodiment, the working side of the initiator magnet is perpendicular to the axis of the housing. In other embodiments, however, the working side of the initiator magnet can be disposed at any angle between 0° (or about 0°) and 180° (or about 180°) with respect to the axis of the housing.

In one embodiment, the initiator magnet is movable relative to the guide member along a direction that is perpendicular to the corresponding side of the target magnet when the guide member is operably proximate to the target object. In other embodiments, however, the initiator magnet is movable relative to the guide member along a direction that is between 0° (or about 0°) and 180° (or about 180°) relative to the corresponding side of the target magnet when the guide member is operably proximate to the target object.

It will be appreciated that the initiator magnet and target magnet may be any desired size and be capable of generating a magnetic field of any desired strength, depending upon factors such as the mass of the target object, the manner in which the target object is supported by the support structure, the environment in which the target object is located, or the like or a combination thereof. It will also be appreciated that characteristics of the guide member (e.g., size, shape, weight, material(s) forming the housing, etc.) may be selected in any manner making it suitable for receiving the fluid, retaining the initiator magnet, and allowing the initiator magnet to slide toward the target magnet. The guide member may be portable (e.g., so as to be capable of being carried by a person or machine such as a crane) or may be a permanent installation which cannot be moved without first being disassembled. Moreover, in some embodiments, the guide member may be movable relative to the support structure or may be immovable relative to the support structure. In some embodiments, the guide member may be coupled (e.g., moveably or immovably) to the support structure or may not be coupled to the support structure at all.

Specific embodiments will now be described in detail. These examples are intended to be illustrative, and the claims are not limited to the specific implementations set forth in these illustrated embodiments.

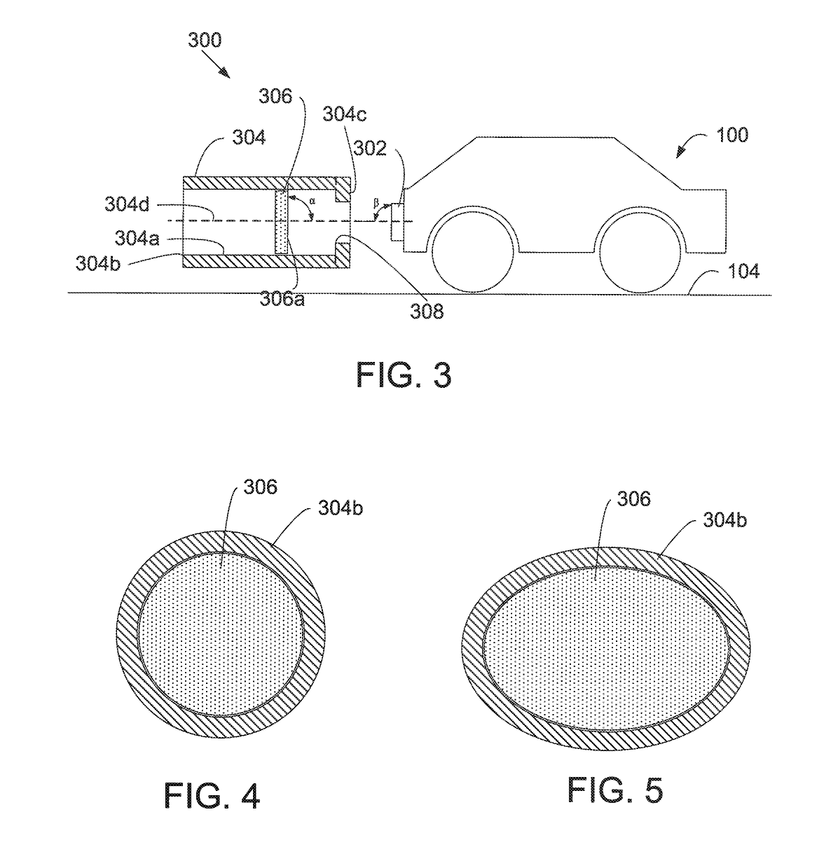

FIG. 3 is a cross-sectional schematic view of an apparatus for moving a target object, according to one embodiment of the invention. FIGS. 4 and 5 are end-views of the guide member shown in FIG. 3, according to some embodiments of the invention.

Referring to FIG. 3, an apparatus 300 for moving a target object 100 to produce mechanical work includes a target magnet 302, a guide member 304, and an initiator magnet 306.

The target magnet 302 is connected to the target object 100, and can be provided as a permanent magnet. The target magnet 302 is immovably connected to the target object 100. As exemplarily shown, the target object 100 is a model car, which is supported by surface of a support structure 104 (e.g., a table). In this illustrative embodiment, the target object 100 can be slid across the surface of the support structure 104.

The guide member defines a guide path along which a fluid (e.g., air) can be transmitted. As illustrated, the guide path is straight. The guide member includes a housing 304 provided as a tubular member having an inner surface 304a defining the guide path. The initiator magnet 306 can be coupled (e.g., moveably coupled) to the housing 304 such that the initiator magnet 306 is slidably received within the guide path. The housing 304 has a fluid intake end 304b and a repulsive end 304c opposite the fluid intake end 304b. An axis 304d of the housing 304 extends between the fluid intake end 304b and the repulsive end 304c. The guide path generally extends along the axis 304d of the housing 304.

The fluid intake end 304b is configured to receive the fluid. Fluid received by the fluid intake end 304b can be channeled into the housing 304 to press against and move the initiator magnet 306 along the guide path (i.e., along the axis 304d of the housing 304) toward the repulsive end 304c of the housing 304. The initiator magnet 306 is provided as a permanent magnet. In one embodiment, the initiator magnet 306 and the target magnet 302 are provided as the same type of magnet. The initiator magnet 306 is disposed within the guide path such that a working side 306a of the initiator magnet 306 faces a corresponding side of the target magnet 302 and has the same polarity as the corresponding side target magnet 302. The working side 306a of the initiator magnet 306 is perpendicular to the axis 304d of the housing 304 (i.e., α=90°). It will be appreciated, however, that a could be any angle in a range between 0° (or about 0°) and 180° (or about 180°).

In the illustrated embodiment, the guide member includes a flange 308 disposed at the repulsive end 304c of the housing 304. The flange 308 may be configured to retain the initiator magnet 306 within the guide path when the initiator magnet 306 is moved by the fluid channeled along the guide path. In the illustrated embodiment, the initiator magnet 306 is movable relative to the housing 304 along a direction that is perpendicular to the corresponding side of the target magnet 302 when the guide member is operably proximate to the target object 100. That is, an angle β between the axis 304d of the housing 304 and the corresponding side of the target magnet 302 is 90°. It will be appreciated, however, that β could be any angle in a range between 0° (or about 0°) and 180° (or about 180°).

Although not illustrated, the guide member may include a flange, such as flange 308, disposed at the fluid intake end of the housing 304 to retain the initiator magnet 306 within the guide path between the fluid intake end 304b and the repulsive end 304c.

The working side 306a of the initiator magnet 306 is substantially prevented from rotating within the guide path about an axis that is perpendicular to the axis 304d of the housing 304 when the initiator magnet 306 is moved along the guide path toward the repulsive end of the housing. For example, dimensions defining the shape of the working surface 306a the initiator magnet 306 (see, e.g., FIG. 4) and the thickness of the initiator magnet 306 (see, e.g., FIG. 3) are selected to substantially prevent the initiator magnet 306 from rotating within the guide path about an axis that is perpendicular to the axis 304d of the housing 304.

In the embodiment illustrated in FIG. 4, the working side 306a of the initiator magnet 306 is free to rotate within the guide path along an axis that is parallel with the axis 304d of the housing 304. In another embodiment, however, the working side 306a of the initiator magnet 306 can be substantially prevented from rotating within the guide path about an axis that is parallel with the axis 304d of the housing 304. For example, referring to FIG. 5, dimensions defining the shape of the working surface 306a of the initiator magnet 306 and the shape of the inner surface 304a of the housing 304 are selected such that the initiator magnet 306 is substantially prevented from rotating within the guide path about an axis that is parallel with the axis 304d of the housing 304.

As exemplarily illustrated in FIG. 5, the shape of the working surface 306a of the initiator magnet 306 and the shape of the inner surface 304a of the housing 304 are the same, but the shape of the working surface 306a is slightly smaller than the guide path defined by the inner surface 304a of the housing 304. The working surface 306a of the initiator magnet 306 and the inner surface 304a of the housing 304 can each have any shape with a rotational symmetry, n, where n is any integer. In other embodiments, however, the shape of the working surface 306a of the initiator magnet 306 and the shape of the inner surface 304a of the housing 304 may be different.

A lubricant (not shown) may be provided between the initiator magnet 306 and the inner surface 304a of the housing 304. In one embodiment, the lubricant may be provided as a PTFE coating formed on the initiator magnet 306, the inner surface 304a of the housing 304 or a combination thereof.

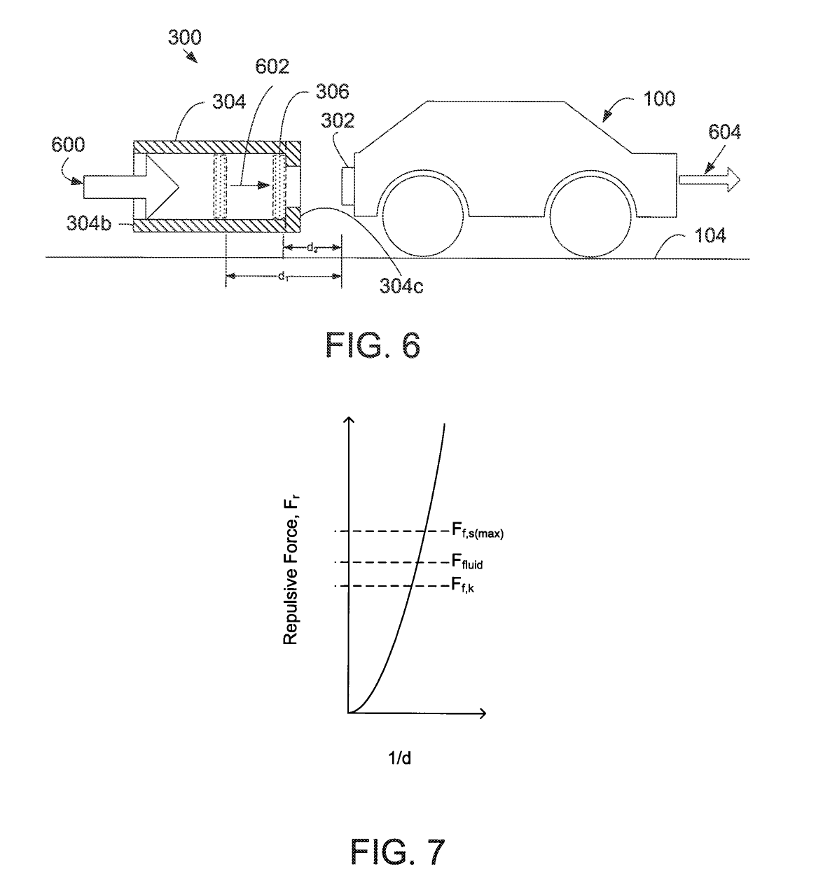

Having described an exemplary apparatus 300 for producing work above with respect to FIGS. 3-5, an exemplary discussion of the operation of the apparatus 300 will be provided with respect to FIGS. 6 and 7 in which FIG. 6 is a schematic view illustrating how the apparatus shown in FIG. 3 produces mechanical work and FIG. 7 is a graph illustrating the effect of the distance between the target object and the initiator magnet shown in FIG. 6 on the repulsive force experienced by the target object.

Referring to FIG. 6, the guide member is disposed such that the housing 304 is located operably proximate to the target object 100. A mechanical force (e.g., as indicated by arrow 600) is generated by a fluid that is received by the fluid intake end 304b of the housing 304. The initiator magnet 306 is slidably moved along the guide path (i.e., along axis 304d of housing 304, in the direction indicated by arrow 602) toward the repulsive end 304c of the housing 304 under the influence of a mechanical force 600 generated by the fluid as it is transmitted along the guide path. When the initiator magnet 306 is moved toward the repulsive end 304c of the housing 304, the distance, d, between the target magnet 302 and the initiator magnet 306 can be decreased (e.g., from d₁ to d₂) to increase a repulsive force between the target magnet 302 and the initiator magnet 306. When the repulsive force is greater than a friction force between the target object 100 and the support structure 104, the target object 100 will move relative to the support structure 104 (e.g., in the direction indicated by arrow 604).

Referring to FIG. 7, the repulsive force (Fᵣ) that can be generated is greater than a kinetic friction force (F_{f,k}) between the target object 100 and the support structure 104. In another embodiment, the repulsive force (Fᵣ) that can be generated is greater than a static friction force (F_{f,s(max)}) between the target object 100 and the support structure 104. In FIG. 7, F_{fluid} corresponds to the magnitude of the mechanical force generated by fluid that is flowing outside the apparatus 300 and acting upon the target object 100. Therefore, the apparatus 300 is capable of initiating movement of the target object 100 relative to the supporting structure 104 in the presence of an applied mechanical force (Fᵣ) that sufficiently overcomes the static friction force (F_{f,s(max)}) between the target object 100 and the supporting structure 104. Movement of the target object 100 relative to the supporting structure 104 can thereafter be sustained by the mechanical force (F_{fluid}) generated by fluid that is flowing outside the apparatus 300 and acting upon the target object 100.

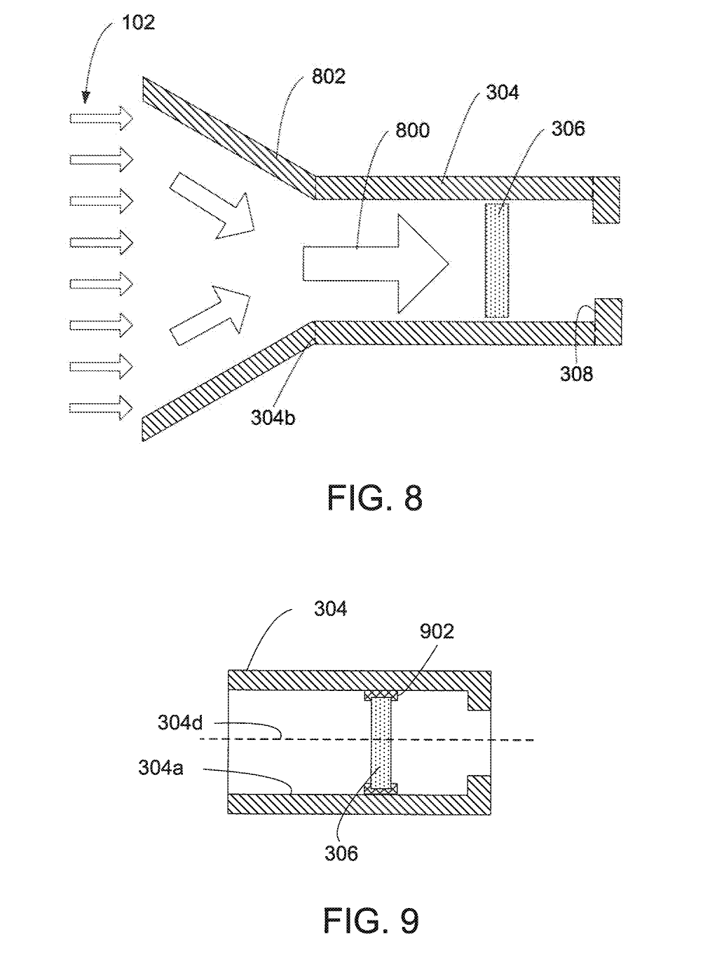

FIG. 8 is a cross-sectional schematic view of an apparatus for moving a target object, according to another embodiment of the invention.

Referring to FIG. 8, the guide member may include a nozzle 802 disposed at the fluid intake end 304b of the housing 304. The nozzle 802 may be provided as a convergent nozzle, having a diameter that decreases in the direction of fluid flow into the housing, to increase the volume of fluid channeled along the guide path and accelerate the velocity of fluid flow into the housing 304. By increasing the volume of fluid channeled along the guide path and accelerating the velocity of fluid flow into the housing 304, the mechanical force generated by the fluid within the guide member (e.g., as indicated by arrow 800) can be increased relative to the mechanical force indicated by arrow 600 in FIG. 6.

FIG. 9 is a cross-sectional schematic view of an apparatus for moving a target object, according to another embodiment of the invention.

In the embodiments discussed above, dimensions defining the shape of the working surface 306a the initiator magnet 306 (see, e.g., FIGS. 4 and 5) and the thickness of the initiator magnet 306 (see, e.g., FIG. 3) are selected to substantially prevent the initiator magnet 306 from rotating within the guide path about an axis that is perpendicular to the axis 304d of the housing 304. In another embodiment, however, one or more suitably-dimensioned spacers may be coupled to the initiator magnet 306 to substantially prevent the initiator magnet 306 from rotating within the guide path about an axis that is perpendicular to the axis 304d of the housing 304. For example, referring to FIG. 9, one or more suitably-dimensioned spacers 902 may be coupled to the initiator magnet to substantially prevent the initiator magnet 306 from rotating within the guide path about an axis that is perpendicular to the axis 304d of the housing 304.

In one embodiment, a single spacer 902 is provided which surrounds the entire perimeter of the initiator magnet 306. In another embodiment, a single spacer 902 is provided which surrounds the more than half the entire perimeter of the initiator magnet 306. In yet another embodiment, spacers 902 are disposed around the perimeter of the initiator magnet 306 and may be spaced apart from each other at regular intervals.

In one embodiment, the one or more spacers 902 are provided as a bearing such as a bushing, a rolling element bearing assembly (e.g., including one or more ball bearing, one or more roller bearing, etc.), and the like and combinations thereof. In embodiments where the bearing is a bushing, the bushing may include one or more dry lubricants such as polytetrafluoroethylene (PTFE), graphite, hexagonal boron nitride, molybdenum disulfide tungsten disulfide, or the like or combinations thereof.

While the embodiments of the present invention have been particularly shown and described above, it will be understood by one of ordinary skill in the art that various changes in form and details may be made therein without departing from the spirit and scope of the present invention as defined by the following claims.

What is claimed is:

1. An apparatus for producing mechanical work, comprising:
a target magnet connected to a target object;
a guide member configured to transmit a fluid along a guide path; and
an initiator magnet having a working side facing a corresponding side of the target magnet with a same magnetic polarity as the corresponding side, the initiator magnet being slidably received within the guide path of the guide member, and wherein the initiator magnet is movable toward the target magnet along the guide path under influence of the fluid transmitted by the guide member to thereby create an increasing repulsive force between the target magnet and the initiator magnet as a distance between the target magnet and the initiator magnet decreases to thereby move the target object.

2. The apparatus of claim 1, wherein the guide member comprises a housing having a fluid intake end and a repulsive end opposite the fluid intake end, wherein the initiator magnet is disposed between the fluid intake end and the repulsive end.

3. The apparatus of claim 2, wherein the guide member further comprises a nozzle disposed at the fluid intake end of the housing, the nozzle configured to accelerate the fluid.

4. The apparatus of claim 2, wherein the guide member further comprises a flange disposed at the repulsive end of the housing, the flange configured to retain the initiator magnet within the guide path at a location adjacent to the repulsive end of the housing.

5. The apparatus of claim 1, wherein the housing is a tubular housing having an inner surface extending between the fluid intake end and the repulsive end, wherein the inner surface defines the guide path.

6. The apparatus of claim 5, wherein the guide path extends along the axis of the housing.

7. The apparatus of claim 6, wherein the working side of the initiator magnet is disposed at an angle in a range between about 0° and about 180° with respect to the axis of the housing.

8. The apparatus of claim 7, wherein the working side of the initiator magnet is disposed at an angle of about 90° with respect to the axis of the housing.

9. The apparatus of claim 6, wherein an angle between the axis of the housing and the corresponding side of the target magnet is in a range between about 0° and about 180°.

10. The apparatus of claim 9, wherein the angle between the axis of the housing and the corresponding side of the target magnet is about 90°.

11. The apparatus of claim 3, further comprising a lubricant between the initiator magnet and the inner surface of the housing.

12. The apparatus of claim 3, further comprising a bearing between the initiator magnet and the inner surface of the housing.

13. The apparatus of claim 1, wherein the fluid includes a gas.

14. The apparatus of claim 1, wherein the fluid includes a liquid.

15. The apparatus of claim 1, wherein at least one of the initiator magnet and the target magnet is a permanent magnet.

16. The apparatus of claim 1, wherein the initiator magnet is moveably coupled to the guide member.

17. The apparatus of claim 1, wherein the target magnet is immovably connected to the target object.

18. The apparatus of claim 1, wherein the guide member is moveable relative to the support structure.

19. An apparatus for moving a target object contacting a support structure, comprising:
a target magnet connected to the target object;
a guide member; and
an initiator magnet coupled to the guide member and having a working side facing a corresponding side of the target magnet with a same magnetic polarity as the corresponding side,
wherein the initiator magnet is movable relative to the guide member under influence of a mechanical force to thereby create an increasing repulsive force between the target magnet and the initiator magnet as a distance between the target magnet and the initiator magnet decreases, wherein the increasing repulsive force is greater than a friction force between the target object and the support structure.

20. The apparatus of claim 19, wherein the friction force is a static friction force.
